(19) United States
(12) Patent Application Publication
(10) Pub. No.: US 2016/0117769 A1
(43) Pub. Date: Apr. 28, 2016

(54) STAKEHOLDER NOTIFICATION

(71) Applicant: International Business Machines Corporation, Armonk, NY (US)

(72) Inventors: Chitwan Humad, Pune (IN); Soumitra G. Limaye, Pune (IN); Rulesh F. Rebello, Vasai (IN); Manas R. Senapati, Pune (IN); Shankar Venkatachalam, Tamil Nadu (IN)

(21) Appl. No.: 14/715,630

(22) Filed: May 19, 2015

Related U.S. Application Data
(63) Continuation of application No. 14/525,481, filed on Oct. 28, 2014.

(51) Int. Cl. G06Q 40/04; H04L 12/58

(52) U.S. Cl. CPC G06Q 40/04; H04L 51/24

(57) ABSTRACT

As disclosed herein a method, executed by a computer, for enabling stakeholder notification includes receiving a message that indicates a stakeholder for a message and responding to an identified stakeholder without requiring user intervention. The stakeholder, specified by a stakeholder indicator, may be an address, a label, or the like that is included in a message header or embedded in the message. A messaging client may auto-populate the stakeholder indicator with a specified user, such as, a supervisor of the user preparing the message. Activation of the stakeholder field may be a configurable setting configured through email client options, or alternatively may be manually selected by the message author at the time of message creation. A user interface may be available allowing an identified stakeholder to request removal as a stakeholder. A computer system, and computer program product corresponding to the method are also disclosed herein.

### FIELD OF THE INVENTION

The present invention relates generally to the field of communication, and more particularly to electronic messaging methods and systems.

### BACKGROUND OF THE INVENTION

Electronic mail and meeting notices are messages distributed by electronic means from one computer user to one or more recipients via an intranet or internetwork. With current email technology, it is only the author of the message that automatically receives responses from the message recipients. Current email technology enables the author of an email message to receive various notifications via responses from recipients of the message. Responses to the message author include, edited responses, auto-responses (e.g., out of office, vacation responses) as well as actionable responses (e.g., accepting, declining, countering, and delegating a meeting invitation).

### SUMMARY

As disclosed herein a method, executed by a computer, for enabling stakeholder notification includes receiving a message that indicates a stakeholder for a message and responding to an identified stakeholder without requiring user intervention. The stakeholder, specified by a stakeholder indicator, may be an address, a label, or the like that is included in a message header or embedded in the message. A messaging client may auto-populate the stakeholder indicator with a specified user, such as, a supervisor of the user preparing the message. Activation of the stakeholder field may be a configurable setting configured through email client options, or alternatively may be manually selected by the message author at the time of message creation. If active, the stakeholder field may be manually updated by the message creator. A user interface may be available allowing an identified stakeholder to request removal as a stakeholder. A computer system, and computer program product corresponding to the method are also disclosed herein.

### BRIEF DESCRIPTION OF THE SEVERAL VIEWS OF THE DRAWINGS

FIG. 1 is a functional block diagram of one embodiment of a message processing environment in which at least some of the embodiments disclosed herein may be deployed;

FIG. 2 is a flowchart depicting one embodiment of a message creation method;

FIGS. 3a and 3b are diagrams depicting embodiments of email headers including an option to enable or disable stakeholder functionality;

FIG. 4 is a diagram depicting one embodiment of a meeting notice including an option to enable or disable stakeholder functionality

FIG. 5 is a flowchart depicting one embodiment of an auto-response processing method;

FIGS. 6a and 6b are diagrams depicting embodiments of an email header and meeting header enabling the removal of a stakeholder;

FIG. 7 is a flowchart depicting one embodiment of a stakeholder removal method; and

FIG. 8 is a block diagram depicting various components of one embodiment of a computer suitable for executing the methods disclosed herein.

### DETAILED DESCRIPTION

In a global society that is increasingly more and more dependent on immediate electronic communications and notifications, there is a business critical need for others, in addition to the author, to be notified of recipient responses to email messages. However, current email implementations do not accommodate automatic notification of stakeholders, other than the message author. For example, the author of a message sends a correspondence to his team requesting time critical work be completed, and wishes his administrative assistant to receive any notices (e.g., out of office notices) that may indicate the need for additional follow-up. The embodiments disclosed herein provide a method for enabling stakeholder notification.

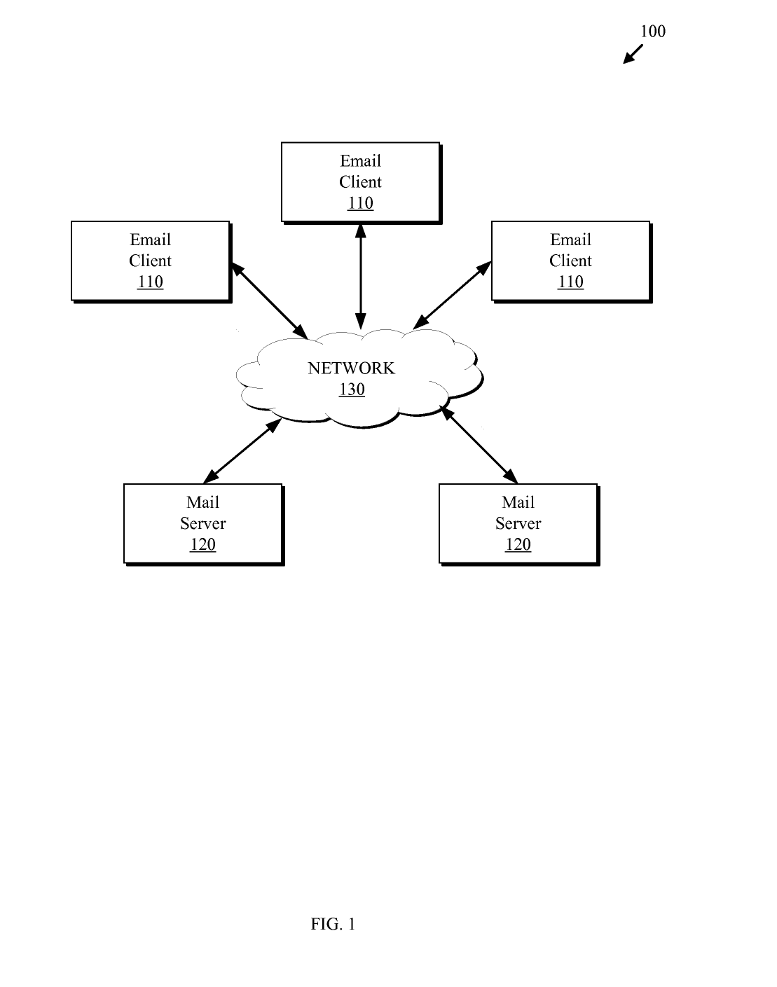

FIG. 1 is a functional block diagram of one embodiment of a message processing environment 100. As depicted, the message processing environment 100 includes one or more email clients 110, one or more mail servers 120, and a network 130. The message processing environment is one example of an environment in which at least some of the embodiments disclosed herein may be deployed.

Email clients 110 are computer programs used by a user to access and manage their messages (e.g., email and meeting notices). Mail servers 120 store incoming mail for distribution to email clients (i.e., users) and forward outgoing mail through the appropriate channel for delivery to the target recipient. The mail servers 120 may be accessible to the email clients 110 via the network 130 to access and manage messages. In some embodiments the mail servers are also mail clients.

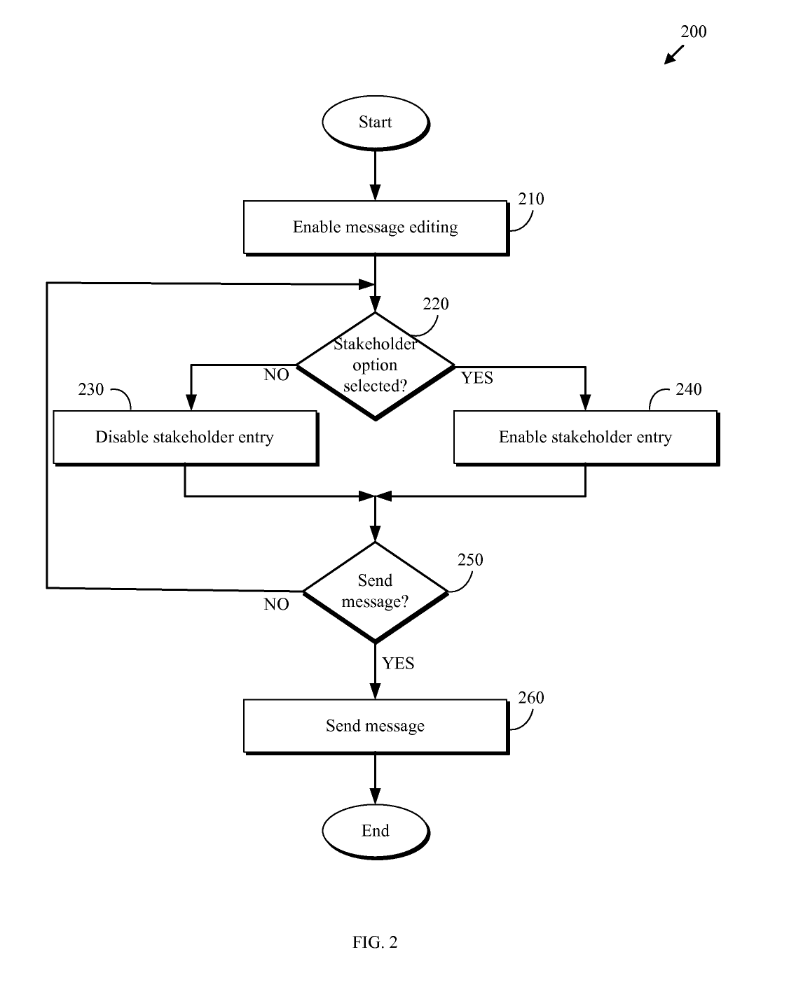

FIG. 2 is a flowchart depicting one embodiment of a message creation method 200. As depicted, the message creation method 200 includes enabling (210) message editing, determining (220) whether a stakeholder option is selected, disabling (230) stakeholder entry, enabling (240) stakeholder entry, determining (250) whether the message is to be sent, and sending (260) a message. The message creation method 200 enables an email client to access and manage (e.g., respond to) an existing message or compose an original message.

Enabling (210) message editing may include enabling a message author to compose a message. The message may be in the form of an email. The message author may enter a message recipient, a message subject, a message body, a file attachment, or similar information. For example, the author may compose a new message which does not correspond any previously received messages. Alternatively, the author may compose a response corresponding to a message that has been received.

The message may be in the form of a notification, such as a meeting notification. The message author may compose a new meeting notification and enter a meeting notification recipient, a meeting notification subject, a meeting date, a meeting start time, a meeting stop time, a meeting location, or similar information. Alternatively, the message author may decline a meeting invitation corresponding to a meeting notification and add text to the response indicating a reason for his action. In addition to email messages and meeting notifications, the message may include other electronic forms of communication such as appointments, events, instant messaging, blogging, tweeting and the like.

Determining (220) whether the stakeholder option is selected may include an iterative operation of verifying if a message author manually selected an option in a message header to enable entry of a stakeholder indicator. Alternatively, the stakeholder option may be globally configurable as a user preference through a messaging client user interface or may be enabled by some other procedure known to those of skill in the art. If the stakeholder option is selected, the depicted method 200 proceeds to the enable stakeholder entry operation 240. Otherwise the method proceeds to the disable stakeholder entry operation 230.

Disabling (230) stakeholder entry may include preventing a message author from entering a stakeholder indicator in a stakeholder field. In one embodiment, the stakeholder field is write protected, preventing the message author from entering a stakeholder indicator. In another embodiment, the stakeholder field is not visible to the message author. Additionally, if the message is a response to a corresponding received message, operations to include a stakeholder indicator in the distribution of the message may be deactivated. If present, the feature for removing the stakeholder indicator corresponding to the message author from the stakeholder list may be removed or deactivated.

Enabling (240) stakeholder entry may include enabling a message author to enter a stakeholder indicator in a stakeholder field. In one embodiment, the stakeholder field is set to be write enabled allowing the message author to enter a stakeholder indicator in a stakeholder field. In another embodiment, the stakeholder field is changed to be a visible field. A stakeholder indicator corresponding to a supervisor may be included as a stakeholder. Additionally, if the message is a response to a corresponding message, operations to include a stakeholder indicator in the distribution of the message may be enabled. The option for removing the stakeholder indicator corresponding to the message author from the stakeholder list may be enabled.

Determining (250) whether the message is to be sent may include verifying if the message author has initiated a request to send the message. If the message author has initiated a request to send the message, the message proceeds with the send operation 260. Otherwise the method iterates to determining (220) whether the stakeholder option is selected.

Sending (260) a message may include directing the message to a mail server. In one embodiment, the auto-response message is directed from an email client to a message recipient. Directing a message may include sending a message, responding to a message, or the like.

The electronic message transmission may occur over intra networks, internetworks or combinations thereof. The electronic message transmission may include a series of coordinated exchanges between mail servers, SMTP servers, DNS servers, POP3 servers, IMAP servers and the like. If the stakeholder entry is enabled, a stakeholder indicator may be included in the message header as a recipient during the send operation.

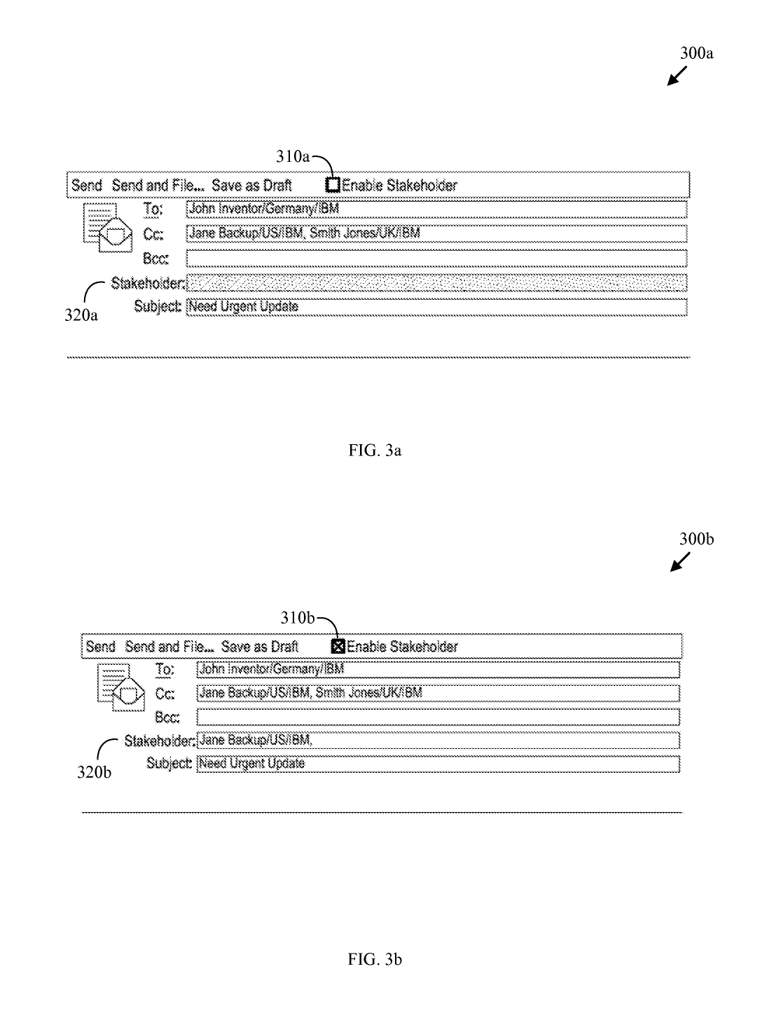

FIGS. 3a and 3b are user interface diagrams of a header editor 300 for an email message. FIG. 3a shows the header editor 300 with the enable stakeholder option in an unselected state 300a while FIG. 3b shows the header editor 300 with the enable stakeholder option in a selected state 300b. FIGS. 3a and 3b depict embodiments of header editor 300 which include a selectable option 310 to enable or disable stakeholder functionality (e.g., 310a and 310b), and a stakeholder field 320 (e.g., 320a and 320b) for identifying stakeholder identifiers. The header editor 300 enables message authors to manage the message behavior through, but not limited to, configurable message options, recipient fields, and text areas.

In FIG. 3a, the enable stakeholder option 310a is not selected and the stakeholder field 320a is write protected, preventing the entry of a stakeholder indicator. In the depicted configuration, no additional operations related to stakeholder notifications will be possible. In FIG. 3b, the enable stakeholder option 310b is selected and the stakeholder field 320b is editable, allowing entry of a stakeholder indicator. The stakeholder indicator (Jane Backup/US/IBM) may receive any notification that is delivered to the message author.

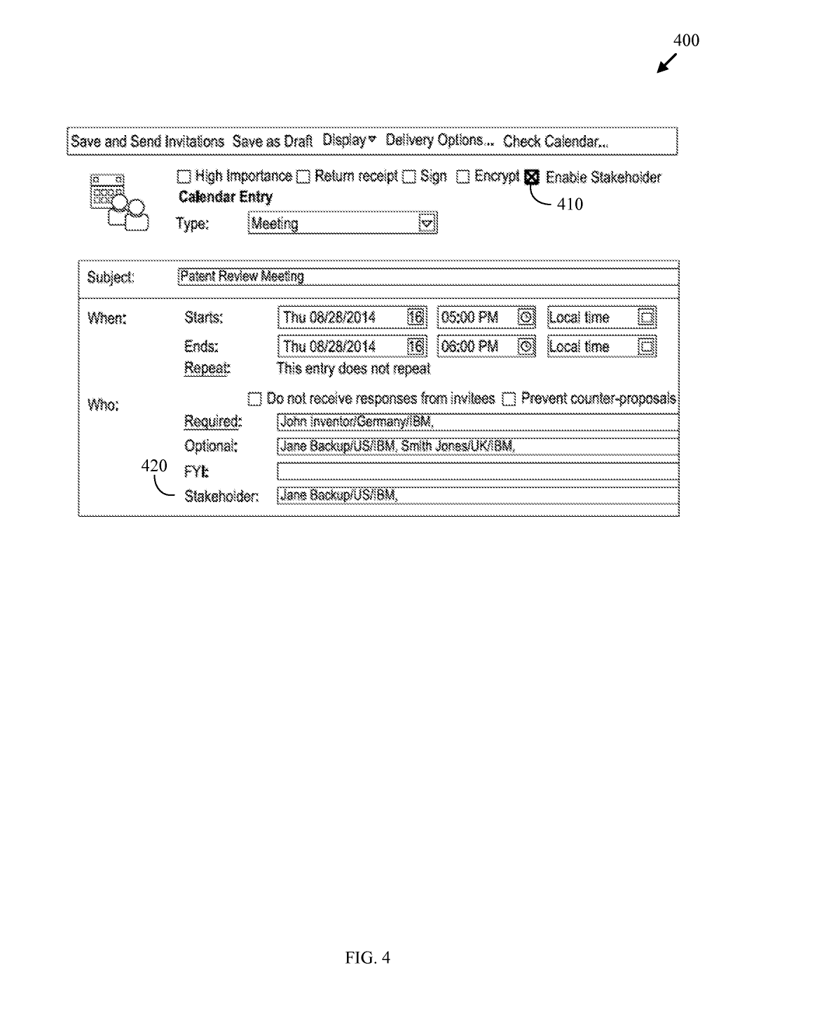

FIG. 4 is a user interface diagram of a header editor 400 for a meeting notification message. As depicted, header editor 400 includes a selectable enable stakeholder option 410 and a stakeholder field 420, among other traditional meeting notice fields and options. The header editor 400 enables a meeting notification author to manage message behavior through, but not limited to, configurable message options, recipient fields, start and stop date and time sections, and text areas. In FIG. 4, the enable stakeholder option 410 is selected and the stakeholder field 420 is editable, allowing entry of a stakeholder indicator in addition to any normally available fields or selections. The stakeholder indicator (i.e., Jane Backup/US/IBM) may receive any notification delivered to the meeting notification message author.

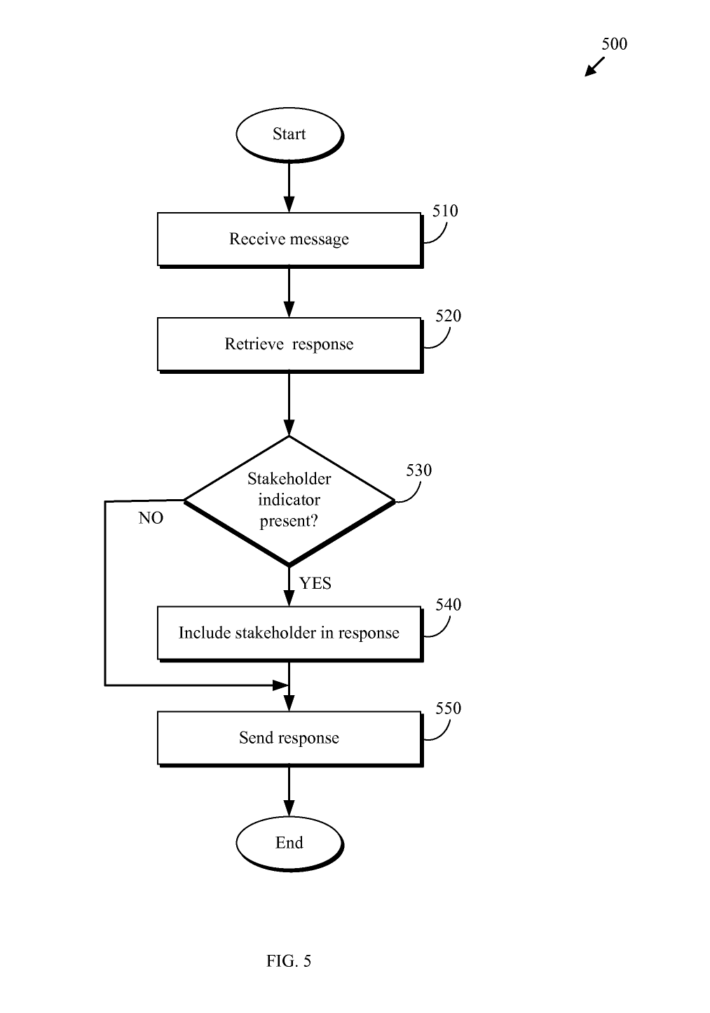

FIG. 5 is a flowchart depicting one embodiment of an auto-response processing method 500. As depicted, the auto-response processing method 500 includes receiving (510) a message, receiving (520) a response, determining (530) whether a stakeholder indicator is present, including (540) a stakeholder in a response, and sending (550) a response. The auto-response processing method 500 enables a mail server or email client to act on the message recipient's behalf and automatically send a response that has been configured and enabled by the message recipient.

Receiving (510) a message may include receiving a message corresponding to a message recipient on a mail server. The message may be an email message, a meeting notification message, or some other message commonly processed by the mail server. The recipient may or may not be actively using an email client at the time the message is delivered to the mail server.

Retrieving (520) a response may include retrieving a prewritten or generic message to be automatically forwarded to the message author. In one embodiment, a mail server is configured by a message recipient to act on the message recipient's behalf. The mail server may retrieve a generic response previously received from the message recipient which may be forwarded to a message author of a received message. In another embodiment, an email client is configured to automatically provide a generic response on behalf of the message recipient. The generic response may be, but is not limited to, an out-of-office message, a vacation message, change of address message, or a mail filtering message.

Determining (530) whether a stakeholder indicator is present may include verifying if a stakeholder indicator is identified in the header as a recipient of a message. If a stakeholder indicator is present, the depicted method 500 proceeds to the include stakeholder operation 540. Otherwise the method 500 proceeds to the send operation 550.

Including (540) a stakeholder in a response may include retrieving a stakeholder indicator from the header information of a received message. The retrieved stakeholder indicator may be added as a recipient in the stakeholder field in the header information of the response.

Sending (550) a response may include directing the response to a message recipient identified in the message header. The recipients may include, but are not limited to, the message author of the originally receive message and any stakeholder indicators included in the automatic response message header.

In one embodiment, the auto-response message is directed from a mail server to a message recipient. In another embodiment, the auto-response message is directed from an email client to a message recipient. Directing a message may include sending a message, responding to a message, or the like. The electronic message transmission may occur over intra networks, internetworks or combinations thereof. The electronic message transmission may include a series of coordinated exchanges between mail servers, SMTP servers, DNS servers, POP3 servers, IMAP servers and the like.

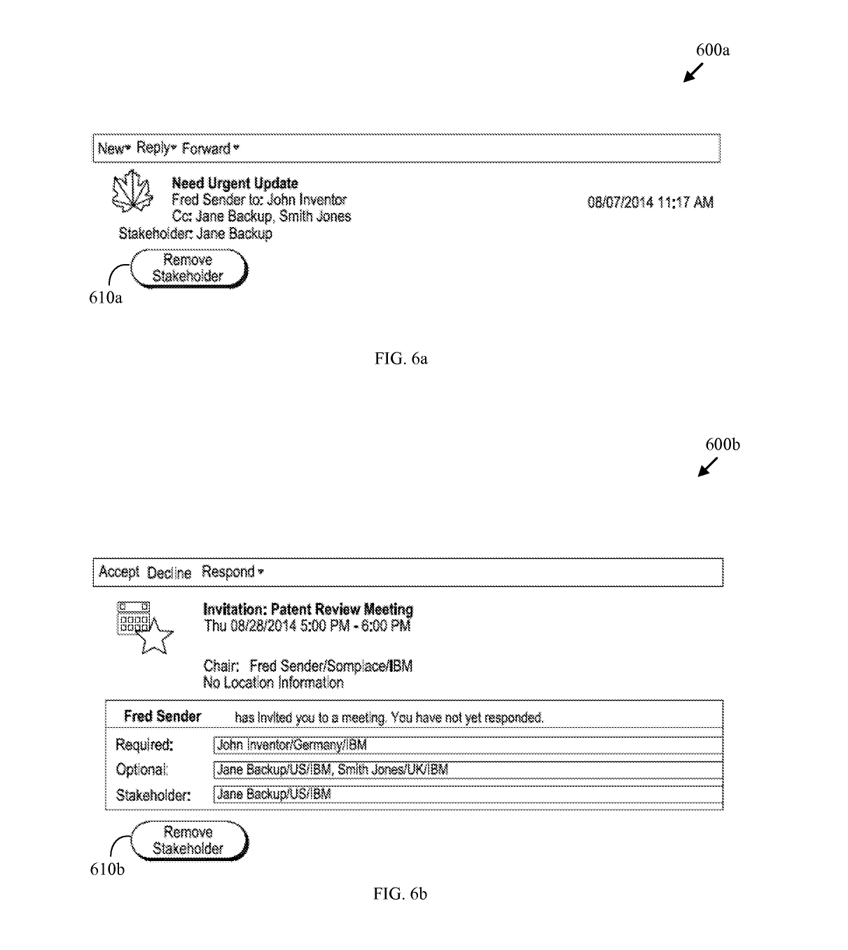

FIGS. 6a and 6b are user interface diagrams of a message header editor 600. FIG. 6a depicts a message header editor 600a for an email message while FIG. 6b depicts a message header editor 600b for a meeting notification message. Each interface includes a remove stakeholder feature 610 (i.e., 610a and 610b). The depicted message header editor 600 may be presented when a message recipient is viewing a message they have received.

The remove stakeholder feature 610 is active in the message header editor 600 when the message recipient is identified as a stakeholder. The message recipient may be removed from future stakeholder notifications if they initiate a removal process by selecting the remove stakeholder feature 610. In one embodiment, selecting the remove stakeholder feature 610 includes a mouse click. In another embodiment selecting the remove stakeholder feature 610 includes touching the feature on a touch screen. Alternatively, selecting the remove stakeholder feature 610 may include tabbing to the feature to bring focus to the stakeholder feature 610 and depressing an enter key on a keyboard.

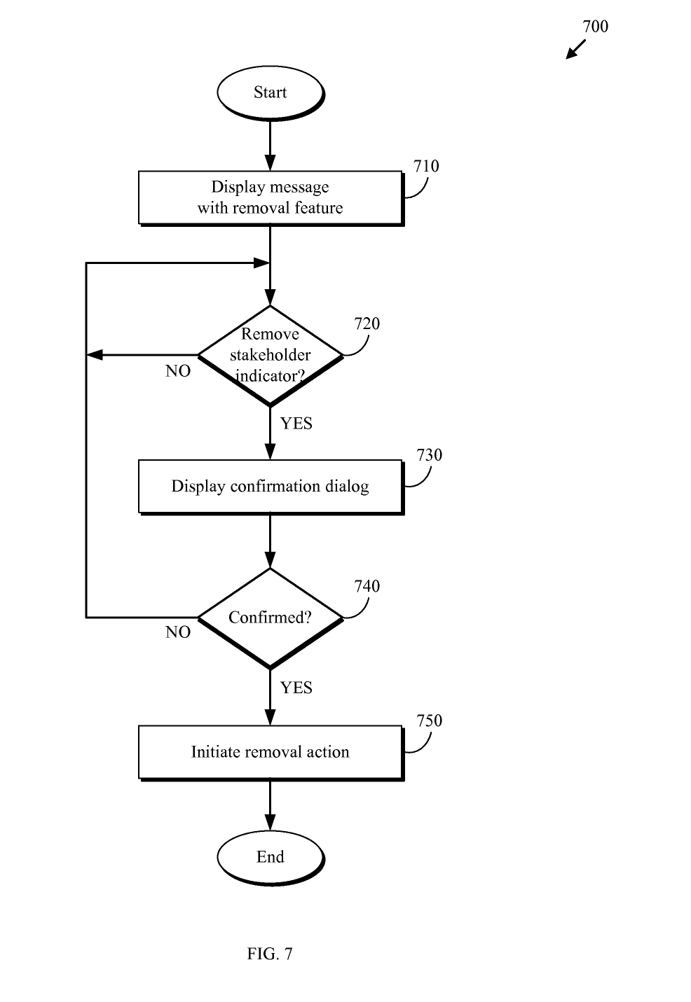

FIG. 7 is a flowchart depicting one embodiment of a stakeholder removal method 700. As depicted, the stakeholder removal method 700 includes displaying (710) a message with the removal feature, determining (720) whether stakeholder removal has been requested, displaying (730) a confirmation dialog, determining (740) whether the removal request was confirmed and initiating (750) a removal action. The stakeholder removal method 700 enables a message recipient to initiate an operation that may remove them from future stakeholder notification messages corresponding to the current message.

Displaying (710) a message with a removal feature may include a message recipient using an email client to connect to a mail server and retrieve a message. The message header may have a stakeholder indicator corresponding to the message recipient. The message may be displayed to the message recipient using a message viewer, a message editor, or some other means known to those of skill in the art. The message may be an email message, a meeting notification message, or some other message commonly processed by the email client.

Determining (720) whether stakeholder indicator removal has been requested may include iteratively checking if the remove stakeholder feature 610 has been selected. In one embodiment, monitoring is performed as an iterative check to determine if the stakeholder feature 610 has been activated. In another embodiment, monitoring is performed as an event handler waiting for a removal event to be triggered. If stakeholder removal has been requested, the depicted method 700 proceeds to the display (730) a confirmation dialog. Otherwise, the method 700 continues to iteratively determine if stakeholder removal has been requested.

Displaying (730) a confirmation dialog may include presenting a dialog box to the message recipient requesting a confirmation that removal is requested. Any additional processing of the received message may be prohibited until the message recipient sufficiently acknowledges the dialog box. The response may be in the form of text entry to an input field, clicking a button to either confirm or deny the request, or some other means familiar to those in the art.

Determining (740) whether the removal request was confirmed may include retrieving a response from the confirmation dialog 730. If the response confirms the request, then the stakeholder removal method 700 proceeds to the initiate (750) removal action. Otherwise, the method 700 continues to iteratively determine if stakeholder removal has been requested.

Initiating (750) a removal action may include removing the stakeholder indicator corresponding to the message recipient from the stakeholder field. In one embodiment, an email client agent initiates the removal operation by forwarding the removal request to the mail server of each message recipient. The removal request operation is processed by each mail server. In another embodiment, an email client configures a filter which will eliminate stakeholder notifications corresponding to the received message from reaching the message recipient. Those of skill in the art will appreciate that there are many possibilities for processing a removal action and eliminating future stakeholder notifications.

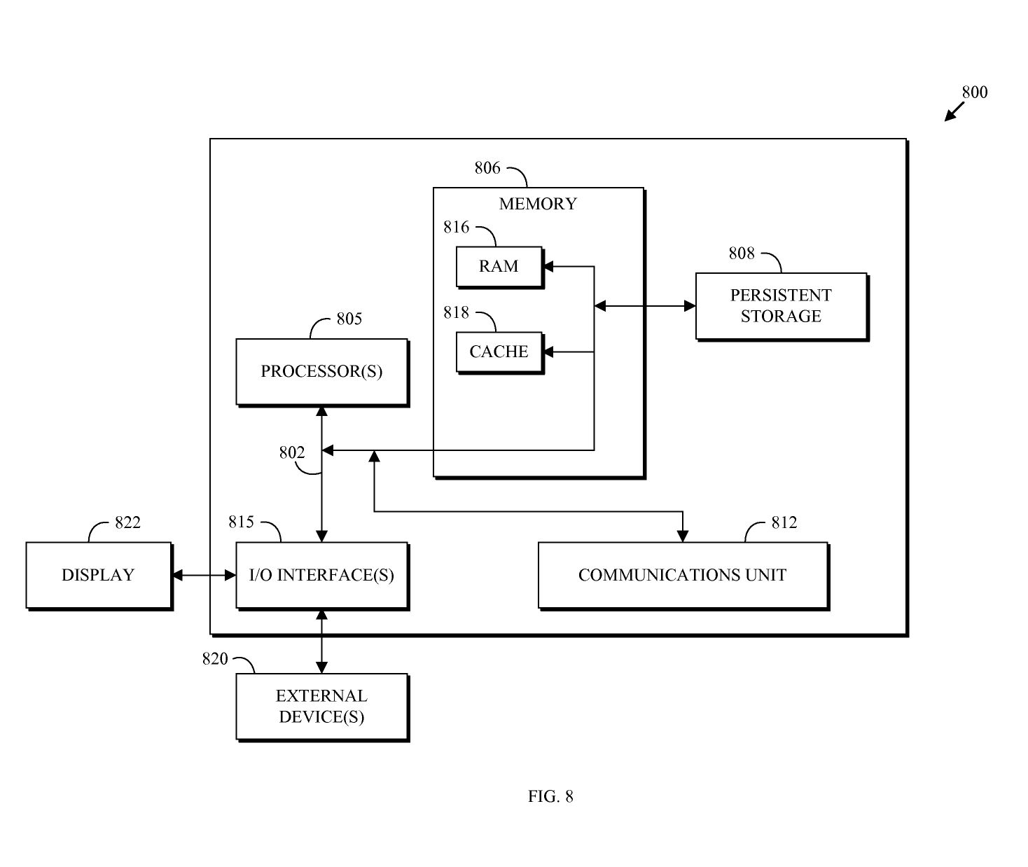

FIG. 8 is a block diagram depicting one example of a computing apparatus (i.e., computer) suitable for executing the methods disclosed herein. The computer 800 may be one embodiment of the email client 110 depicted in FIG. 1. It should be appreciated that FIG. 8 provides only an illustration of one implementation and does not imply any limitations with regard to the environments in which different embodiments may be implemented. Many modifications to the depicted environment may be made.

As depicted, the computer 800 includes communications fabric 802, which provides communications between computer processor(s) 805, memory 806, persistent storage 808, communications unit 812, and input/output (I/O) interface(s) 815. Communications fabric 802 can be implemented with any architecture designed for passing data and/or control information between processors (such as microprocessors, communications and network processors, etc.), system memory, peripheral devices, and any other hardware components within a system. For example, communications fabric 802 can be implemented with one or more buses.

Memory 806 and persistent storage 808 are computer readable storage media. In this embodiment, memory 806 includes random access memory (RAM) 816 and cache memory 818. In general, memory 806 can include any suitable volatile or non-volatile computer readable storage media.

One or more programs may be stored in persistent storage 808 for execution by one or more of the respective computer processors 805 via one or more memories of memory 806. The persistent storage 808 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 808 may also be removable. For example, a removable hard drive may be used for persistent storage 808. Other examples include optical and magnetic disks, thumb drives, and smart cards that are inserted into a drive for transfer onto another computer readable storage medium that is also part of persistent storage 808.

Communications unit 812, in these examples, provides for communications with other data processing systems or devices. In these examples, communications unit 812 includes one or more network interface cards. Communications unit 812 may provide communications through the use of either or both physical and wireless communications links.

I/O interface(s) 815 allows for input and output of data with other devices that may be connected to computer 800. For example, I/O interface 815 may provide a connection to external devices 820 such as a keyboard, keypad, a touch screen, and/or some other suitable input device. External devices 820 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 808 via I/O interface(s) 815. I/O interface(s) 815 also connect to a display 822. Display 822 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, executed by a computer, for stakeholder notification, the method comprising:
receiving a message that indicates a stakeholder for the message; and;
directing a response to the message to the stakeholder without requiring user intervention.

2. The method of claim 1, wherein the stakeholder is specified by a stakeholder indicator.

3. The method of claim 2, wherein the stakeholder indicator is an address or a label.

4. The method of claim 2, wherein the stakeholder indicator is message embedded text.

5. The method of claim 2, wherein the stakeholder indicator is auto-populated by a messaging client.

6. The method of claim 5, wherein the stakeholder is a supervisor of a user of the messaging client.

7. The method of claim 5, wherein the stakeholder is specified in a user preference for the messaging client.

8. The method of claim 2, wherein the stakeholder indicator is manually specified by a message author.

9. The method of claim 2, wherein the stakeholder indicator is editable by a message recipient.

10. The method of claim 1, further comprising providing a user interface feature that enables the stakeholder to be removed from further communication.
